(19) United States
(12) Patent Application Publication
(10) Pub. No.: US 2026/0003025 A1
(43) Pub. Date: Jan. 1, 2026

(54) TAGGING AND TRACKING OF OBJECTS WITH AMBIENT RADIO FREQUENCY SIGNALS

(71) Applicant: Georama, Inc., Chicago, IL (US)

(72) Inventor: Nihal Advani, Chicago, IL (US)

(21) Appl. No.: 19/253,579

(22) Filed: Jun. 27, 2025

Related U.S. Application Data
(60) Provisional application No. 63/666,002, filed on Jun. 28, 2024.

(51) Int. Cl. G01S 5/02

(52) U.S. Cl. CPC G01S 5/02527; G01S 5/02525

(57) ABSTRACT

Methods, systems, and apparatus, including computer programs encoded on computer storage media, for ambient radio frequency signal tracking. One of the methods includes detecting, using one or more detectors in the environment, scattered radio frequency signals scattered by a label attached to an object, the label comprising at least one layer of material that encodes information into ambient radio frequency signals scattered by the label, the information comprising identifying information that uniquely identifies the object; locating, based on the scattered radio frequency signals, the object in the environment; generating, based on the location, mapping data that represents movement of the object in the environment over a period of time; and providing the mapping data to a computer system for analysis.

### RELATED APPLICATION

This application claims priority under 35 U.S.C. § 119(e) to U.S. Provisional Application Ser. No. 63/666,002, filed on Jun. 28, 2024, the disclosures of which are incorporated herein by reference in their entirety.

### BACKGROUND

The radio frequency (“RF”) part of the electromagnetic spectrum is widely utilized for modern wireless communications. For example, 5G wireless communications utilize so-called “sub-6” and “mm Wave” frequency bands. WiFi routers commonly operate using 2.4 GHz or 5 GHz frequencies. Due, at least partially to the prevalence of RF in various forms of wireless communications, most environments in which people live and work are bathed in ambient RF radiation.

Radio Frequency Identification (“RFID”) is a type of wireless technology that can enable tracking and identification using RF signals, optionally including the use of a passive device. Typically, a RFID transmitter emits a first RF signal, and a RFID tag transmits a second RF signal containing data stored in the tag in response to the first RF signal. A reader or detector receives the second signal, which it can analyze to read the data transmitted by the tag. The reader can be part of the same device, or a different device, as the transmitter. A passive RFID tag uses the energy from the transmitted RFID's radio waves, generated by the transmitter, while an active RFID tag contains a power source to enable the tag to transmit information, e.g., radio waves. As a result, an active RFID tag can communicate with RFID readers over longer distances than a passive RFID tag can. However, in either case, the transmitter and/or the tag are the source of the RF signals used to track the tag.

### SUMMARY

In general, one aspect of the subject matter described in this specification can be embodied in methods that include the actions of detecting, using one or more detectors in the environment, scattered radio frequency signals scattered by a label attached to an object, the label comprising at least one layer of material that encodes information into ambient radio frequency signals scattered by the label, the information comprising identifying information that uniquely identifies the object; locating, based on the scattered radio frequency signals, the object in the environment; generating, based on the location, mapping data that represents movement of the object in the environment over a period of time; and providing the mapping data to a computer system for analysis.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, the method can include: for each of at least two or more of a plurality of ambient radio frequency signals scattered by the label attached to the object: determining whether the scattered radio frequency signal likely encodes the identifying information that uniquely identifies the object; for at least a first radio frequency signal from the plurality of ambient radio frequency signals and in response to determining that the scattered radio frequency signal likely encodes the identifying information that uniquely identifies the object: adding the scattered radio frequency signal to a group of scattered radio frequency signals for the object and that will be used to generate the mapping data; and for at least a second radio frequency signal from the plurality of ambient radio frequency signals and in response to determining that the scattered radio frequency signal like does not encode the identifying information that uniquely identifies the object: determining to skip adding the scattered radio frequency signal to the group of scattered radio frequency signals for the object. Generating the mapping data that represents the movement of the object in the environment can use the scattered radio frequency signals from the group of scattered radio frequency signals.

In some implementations, the method can include: for each of at least one or more of a plurality of scattered radio frequency signals, determining whether the scattered radio frequency signal likely encodes the identifying information that uniquely identifies the object; and for a first radio frequency signal from the plurality of scattered radio frequency signals and in response to determining that the scattered radio frequency signal likely encodes the identifying information that uniquely identifies the object, adding the scattered radio frequency signal to a group of scattered radio frequency signals for the object and that will be used to generate the mapping data. Generating the mapping data that represents the movement of the object in the environment can use the scattered radio frequency signals from the group of scattered radio frequency signals.

In some implementations, determining whether the scattered radio frequency signal likely encodes the identifying information that uniquely identifies the object can include: maintaining a database of unique identifiers each of which are for a different object of a plurality of objects and each of which have a different radio frequency scatter pattern; and determining, for at least one unique identifier from the database, that the scattered radio frequency signal likely encodes a scatter pattern for the identifying information that uniquely identifies the object.

In some implementations, the method can include emitting, by one or more emitters, at least one of the radio frequency signals.

In some implementations, at least one of the one or more detectors can include at least one of the one or more emitters.

In some implementations, the label attached to the object can be a passive label that was printed onto the object.

In some implementations, the label can be a passive label. The method can include printing the passive label onto the object.

In some implementations, the label can be an active label. The active label can include a transducer. The transducer can include a battery and a transmitter. The transducer can include a receiver.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can more accurately track individual objects, better distinguish two objects of the same type from each other, or both, compared to other systems by using unique identifiers for the objects. For example, when tracking two identical objects, such as two identical water bottles, e.g., the same product line of water bottle, both bottles could each have a label that encodes a unique identifier for the respective bottle by scattering ambient radio frequency (“RF”) signals differently for the detector to distinctly identify the respective bottle.

In some implementations, a unique identifier can be implemented as a passive RF label to reduce the amount of hardware required on an object compared to other systems, e.g., while still working at a long range. For example, by using passive RF labels, the amount of hardware required is less than the hardware required for an active RF label.

In some implementations, the systems and methods described in this specification can reduce privacy risks, security risks, or both, of tracking objects. For example, when tracking objects in a household, radio frequencies operating at non-visible wavelength can track one or more objects containing the passive labels without cameras or other types of imaging or video devices, reducing a risk of exposure of personal identification and other data.

In some implementations, the systems and methods described in this specification can be implemented with one or more existing RF networks. For example, a RF transmitter, e.g., a router or a long range (“LoRa”) RF gateway, that exists as part of one or more RF networks can transmit ambient RF signals used for other purposes. Those ambient RF signals can be scattered by the passive label for the RF detector to detect, rather than to require a separate RF transmitter for this system, e.g., reducing a requirement for additional hardware. By using existing RF networks, reflective tags, or both, the systems and methods can have a reduced cost, e.g., financial or physical resource, compared to other systems, e.g., active RFID tags.

In some implementations, the system and methods described in this specification can use an active RF label. This can increase an accuracy of the patterns, a distance that the patterns are transmitted, identification of a corresponding object attached to or that includes the active RF label, or any combination of these. In some instances, by using an active RF label, a system can better connect to existing RF detectors, e.g., given scattering of stronger unique patterns.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which one or more environmental RF transmitters emit RF signals.

FIG. 2 is a flow diagram of an example process for generating mapping data.

FIG. 3 is a block diagram of a computing system that can be used in connection with computer-implemented methods described in this specification.

Like reference numbers and designations in the various drawings indicate like elements.

### DETAILED DESCRIPTION

Wireless tracking of objects can be used to gather data for analysis of an object's movement and/or use. For example, wireless tracking of consumer packaged goods (“CPGs”) can provide data relevant to the habits of consumers, information which can be valuable to the producers and sellers of such goods. For instance, data about how often a bottle of laundry detergent is used and moved by a consumer over a weekly period, e.g., by mapping its motion in an environment to determine how often it is used by the consumer, can be valuable data to a manufacturer and/or marketer of the detergent.

To enable tracking of an object, such as the detergent's container, a system uses a passive label that represents a unique identifier attached to the object to scatter, e.g., disperse, ambient RF waves. Although referred to generally as a unique identifier, the passive label can encode, into a radio frequency signal when RF waves scatter off the passive label, any appropriate type of identifying information that uniquely identifies the object given a unique pattern of the passive label. As the object moves around the environment, the ambient RF waves, e.g., emitted by one or more radio frequency (“RF”) sources present in the environment for another purpose, such as a WiFi router, a long range (“LoRa”) RF gateway or 5G network source, are scattered by the passive label. A RF wave detector, e.g., as part of the router, gateway or another device, can detect the scattered RF waves, locate the object in the environment, and generate mapping data that represents movement of the object over a period of time. The label contains material that can scatter RF signals without a separate power source coupled with the label, making the label passive rather than active, e.g., without its own power source.

The passive label contains at least one layer of material that can be a reflective, e.g., conductive, material that is applied to the object that represents a unique identification for the object. The passive label can contain a material that is reflective for RF signals. In some examples the material can be ink or a metallic material, though other examples of reflective material are also considered.

The passive label can have any appropriate type of pattern that causes RF waves to scatter in a unique pattern, representing a unique identifier for the object. For example, the passive label can be a quick response (“QR”) code or bar code that identifies the object. The identification can be unique to that object or that type of object, in that passive labels attached to other objects or types of objects scatter different unique patterns. In some instances, the pattern is selected as a pattern that is not likely naturally occurring, not likely to be in the environment in which the passive label is used, or both.

In some examples, the system can be used to track the motion of CPGs as one form of an object, e.g., a water bottle or bag of chips, and how the product is used by a consumer over time. The passive label can be printed or marked directly onto the CPG, e.g., by a manufacturer of the product, and represent a unique identification specific to that item of the CPG, e.g., instead of that type of item. Some example processes for marking a label can include dot-peen marking, laser marking, or electrolytic chemical etching. An RF detector can detect the RF waves scattered by the passive label on the item, optionally locate the item in an environment, determine movement data of the item using the scattered RF waves, and generate mapping data that represents the movement of the item, such as how consumers interact with, move, and use the item over a period of time.

In some implementations, the label can be implemented as an active label. The active label can include a transducer, e.g., a battery and a RF transmitter, that generates RF waves to scatter the RF waves in the environment. In these implementations, the transducer can emit RF waves in the unique pattern that represents the unique identifier for the object to which the label is attached.

In some examples, the label can be part of an active label. The active label can include an RFID transmitter. The label can include a unique pattern that scatters RF waves reflective off of it, an active RF transmitter that generates RF waves scattered in the corresponding environment, or both. The RFID transmitter can transmit an identifier for the product, e.g., a product identifier that is not necessarily unique. By using the passive label that is unique for the particular instance of the product and the product identifier, the system can more accurately track different instances of the same product, determine how those different instances move, are used, or both, in the same or different manners.

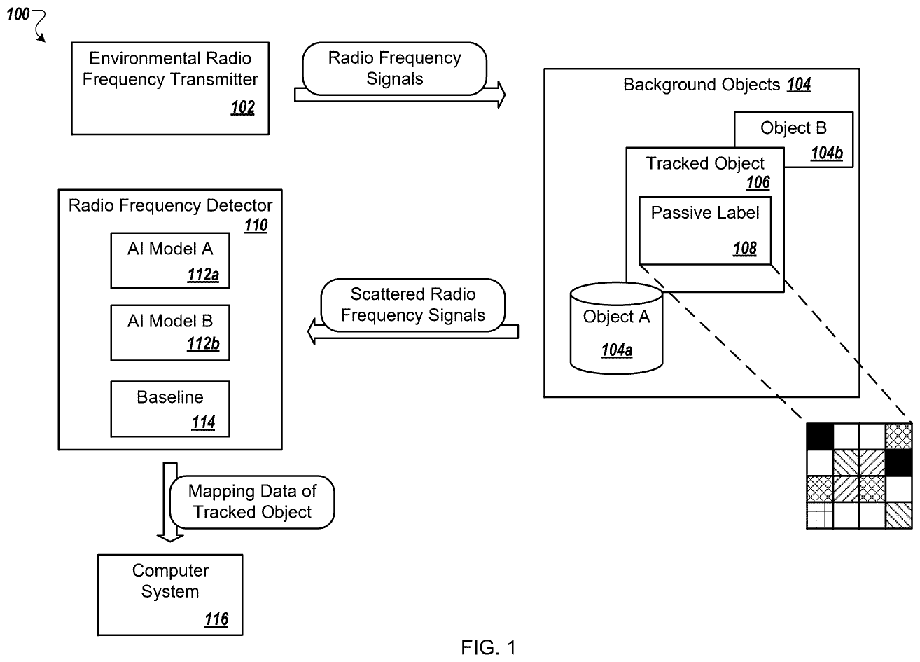

FIG. 1 depicts an example environment 100 in which one or more environmental RF transmitters 102 emit RF signals. These ambient RF signals can be scattered by a passive label 108 on a tracked object 106. The tracked object 106 can be surrounded by, or in the same area as, one or more background objects 104, including objects A and B 104a-b. The RF detector 110 can detect the RF signals scattered by the passive label 108 and use one or more artificial intelligence (“AI”) models, e.g., one or more of the AI Models A-B 112a-b, to locate the object in the environment. The RF detector 110 cause use data about the location of the object in the environment to generate mapping data of the tracked object 106 over a period of time. A computer system 116 can use the mapping data to determine a model for the movement, use, or both, of the tracked object 106 or for other appropriate analysis of the mapping data.

The environmental RF transmitter 102 can be one of multiple types of transmitters, e.g., an existing RF router or gateway or any other appropriate transmitter designed for other RF emission purposes. In some examples, the environmental RF transmitter 102 can be a LoRa gateway. The transmitter can be part of one or more existing RF networks. There can be one or more environmental RF transmitters 102 based on the environment 100 that the system is located in, e.g., a quantity of the environmental RF transmitters 102 can depend on the environment in which the transmitters, object, or both, are located.

The environmental RF transmitter 102 can transmit one or more ambient RF signals. The environmental RF transmitter can emit radio frequencies at one or more of multiple different frequency lengths, such as long range (“LoRa”) RF range, e.g., a sub-gigahertz range; WiFi frequency range, e.g., 2.4 GHz, 5 GHZ, 6 GHz; or any appropriate combination of both.

The tracked object 106 can be any one of one or more different types of objects. For example, the tracked object 106 can be an object such as a CPG, an article of clothing, a robot, or a person. The tracked object 106 can be in any appropriate environment 100 or part of the environment 100, such as a house, commercial building, neighborhood, or public space. Within the environment 100, there can be one or more background objects 104, including an object A 104a and an object B 104b, that are not tracked.

The environmental RF transmitter 102 can be selected such that the environmental RF transmitter 102 transmits RF signals throughout the environment 100, e.g., including through walls and other barriers. The environmental RF transmitter 102 can be selected depending on opt-in preferences, e.g., for people who use the environment 100. When the environment 100 is a house, the environmental RF transmitter 102 can be a shorter-range transmitter, e.g., WiFi. When the environment 100 is a commercial building (depending on the size of the building) or a neighborhood, the environmental RF transmitter 102 can be a longer-range transmitter, e.g., LoRa or 5G.

The passive label 108 can be manufactured using data for the environment 100 in which the tracked object 106 is likely to be located. For instance, a system can select the material, the pattern, or both, for the passive label 108 using data that indicates properties about the environment 100. The material can be selected using a wavelength range for the environmental RF transmitter 102 that are predicted to be in the environment 100. The pattern can be selected using the wavelength for the environmental RF transmitter 102, data for other objects, or both, that are predicted to be in the environment 100.

The background objects 104 can be any appropriate types of objects. For instance, the background objects 104 can be objects that are in the corresponding environment 100 at least a threshold amount of time. For instance, a background object in a commercial building can be an office chair or a piece of equipment while a background object in a house can be a couch or a table.

There can be one or more tracked objects 106 in the environment 100. For example, if there are two soda cans within the environment 100, both can be tracked objects 106, and each object can have its own passive label 108 that represents a unique identifier for the corresponding soda can.

The passive label 108 can contain any appropriate type of material that scatters ambient RF signals. For instance, the passive label 108 can be a reflective, e.g., conductive, ink that can be attached to the tracked object 106. The passive label 108 can be a metallic ink, a metallic sheet, or another appropriate type of material that scatters ambient RF signals, e.g., given the environmental RF transmitter 102. Some example materials can include copper, aluminum, ferrite, e.g., ferrite oxide, an absorptive foam, or any combination of these. In some examples, an active label can be manufactured from similar materials.

The label 108, whether passive or active, can include any appropriate properties, can be manufactured using any appropriate process, or both. For instance, the label can be a substrate. The label can include water proofing. The label can include scratch proofing, e.g., be manufactured from a durable material to reduce a likelihood that the unique pattern is damaged.

The dimensions of the passive label 108, e.g., the thickness, can be selected using one or more properties of the environmental RF transmitter 102, the predicted ambient RF signals for the environment 100, or both. For instance, a system can select the thickness of the passive label 108 using a frequency of the RF signals, e.g., given a skin effect of the RF signals such as LoRa RF signals.

The passive label 108 can be attached to the object 106 in one of multiple appropriate ways. For example, the passive label can be printed onto the object 106, attached with an adhesive to the object 106, or a combination of both. The printing of the passive label 108 onto the object 106 can occur at any appropriate time, e.g., during or after manufacturing of the object 106.

The passive label 108 can be implemented with passive hardware, e.g., a passive RF tag, to use the energy from the ambient RF signals generated from the one or more environmental RF transmitters 102, e.g., rather than using or requiring a battery source on or otherwise coupled to the object to power the passive label 108. For example, the passive RF tag that represents a unique identifier can be attached to a soda can to track how a consumer uses and moves the soda can within the environment 100. This can occur without the need for a separate power source, e.g., on the soda can itself, to power the passive RF tag; without other electronics such as a transmitter; or both.

The passive label 108 can have, e.g., encode, a unique identification for the object 106. For instance, the passive label can include a material that reflects waves, e.g., RF waves, in a unique pattern. Each passive label 108 can be unique in its own corresponding environment 100, everywhere, or some combination of both. By being unique, the passive label 108 can have a different pattern than other passive labels that scatters ambient RF signals differently from other passive labels 108, which allows the tracked object 106 to be identified among other tracked objects 106 that have different patterned passive labels 108. Thus, the passive label 108 can scatter ambient RF signals with a unique pattern for the RF detector 110, e.g., a LoRa detector, to read. For instance, to track two identical water bottles in the same environment 100, the passive label 108 attached to each bottle can contain a different unique pattern, e.g., different unique QR codes, so that the RF detector 110 can detect two distinct patterns of scattered RF signals, one for each bottle. The RF detector could determine the difference between the two water bottles based on their distinct scattered signals and track the movements of both bottles.

The unique identifier represented on the passive label 108 can have information about an orientation of the label based on the specific pattern of the unique identifier, e.g., as part of a QR code. The orientation of the label can provide information about the orientation of the tracked object 106. For example, the passive label 108 can have a square pattern containing multiple smaller squares filled with different patterns. The passive label 108 can have a unique pattern in the bottom-left corner of the square pattern to indicate when the pattern, e.g., the QR code, on the passive label 108 is straight or rotated at a different angle. A change in orientation of the passive label can help determine certain motion of the object 106, such as when the object 106 rotates, changes angle, or direction.

The RF detector 110, e.g., a LoRa detector, can detect the ambient RF signals scattered from the passive label 108, e.g., and other objects in the environment 100 including the background objects 104. Using the unique scattering of the ambient RF signals that were scattered by the passive label 108, the RF detector 110 can determine to which tracked object 106 the passive label 108 is attached. The RF detector 110 can then locate the object in the environment 100 using the unique scattering of the ambient RF signals. The RF detector 110, or another device, can generate mapping data, using the unique scattering of the ambient RF signals, that represents the object's motion over a period of time.

The pattern can be any appropriate type of pattern. For instance, the pattern can be in the form of a QR code, a bar code, a data matrix, or a MaxiCode. Some example bar codes can include PDF417, a high capacity bar code, or a JAB Code. Some example data matrix codes can include Aztec Code, or Semacode.

The RF detector 110 can be part of the same device as the environmental RF transmitter 102 or separate from the environmental RF transmitter 102. For instance, a single device can include both an environmental RF transmitter 102 and an RF detector 110, e.g., receiver. The single device can transmit LoRa signals, other appropriate signals that scatter upon hitting the passive label 108, or a combination of both. In some instances, the environmental RF transmitter 102 can be a LoRa transmitter because a LoRa transmitter can be more likely to generate RF signals that scatter in an identifiable signal upon contacting a label, e.g., instead of being absorbed by the label as might occur with some cellular signals or scattering in an unidentifiable signal given the label's pattern. For example, a LoRa transmitter can be more likely than other types of transmitters to transmit signals in a frequency range that will scatter into an identifiable signal upon contacting the label.

When the environmental RF transmitter 102, the RF detector 110, or both, are LoRa devices, the device can operate with signals at a longer range compared to other types of devices that use other signals. For instance, LoRa signals generated by a LoRa transmitter can go farther, pass through more barriers such as walls, or both, compared to Wi-Fi signals generated by a Wi-Fi transmitter, e.g., router. As a result, use of LoRa signals can enable a LoRa detector to detect objects, e.g., tracked objects, that are further away from the LoRa detector compared to other types of detectors. This can enable the LoRa detector to detect more objects, e.g., across a larger physical area, compared to other types of detectors.

The RF detector 110 can be one of multiple types of detectors, e.g., a type of RF gateway that has customized firmware to receive the ambient RF signals scattered by the passive label 108 or a software defined radio (“SDR”).

The RF detector 110 can be any appropriate type of detector. The RF detector 110 can be part of an existing RF network, for instance, a type of RF gateway. In some instances, the RF detector 110 can be part of a new RF network created for this system, such as an SDR that detects the scattered RF signals from the passive label 108.

The RF detector 110 can detect ambient RF signals in the environment 100 scattered by, for example, one or more background objects 104, which can include objects A 104a and B 104b. Using the RF signals scattered by the background objects 104, the RF detector 110 can develop a baseline model 114 of the environment 100, e.g., mapping data of the background objects 104 without a tracked object 106 in the environment 100. The baseline model 114 can then be used to remove noise from the scattered RF signals from the passive label 108 to more accurately track the object 106.

The RF detector 110 can determine whether an incoming ambient RF signal is likely scattered by the passive label 108 or from the background objects 104. For example, the RF detector can compare the incoming scattered RF signal to the baseline model 114 or to a scattered RF signal from the passive label 108 captured outside of the environment 100, e.g., a signature for the passive label 108, to determine a likelihood that the incoming scattered RF signal was scattered by the passive label 108. The RF detector 110 can compare the likelihood to a likelihood threshold. When the likelihood satisfies the likelihood threshold, e.g., is greater than or equal to, the RF detector 110 can determine that the incoming RF signal was likely scattered from the passive label 108.

When the RF detector 110 detects that the incoming RF signal was likely scattered from the passive label 108, the RF detector can add the incoming RF signal to a group of scattered RF signals from the passive label 108 for the tracked object 106. For instance, the RF detector 110, or another component in the environment 100, can maintain a database of detected RF signals. The database can include one or more data sets each for a corresponding group of scattered RF signals.

The RF detector 110 can use the detected pattern of the passive label 108 to determine to which data set a scattered RF signal should be added. For example, when the RF detector 110 detects a first unique identifier, the RF detector 110 can add data for the corresponding RF signal to a corresponding first data set. When the RF detector 110 detects a second unique identifier, the RF detector 110 can add the second data for the corresponding RF signal to a corresponding second data set.

When the likelihood does not satisfy the likelihood threshold, the RF detector 110 can determine that the incoming RF signal was not likely scattered from the passive label 108. In these instances, the RF detector 110 can discard the incoming RF signal, e.g., delete data representing the incoming RF signal, stop processing the data representing or otherwise related to the incoming RF signal, or both. The data related to the RF signal can include other types of data, such as data from an active label about the object, e.g., accelerometer data.

When the RF detector 110 determines the incoming RF signal is likely scattered from the background objects 104, the RF detector can determine to skip adding the incoming RF signal to any groups of scattered RF signals for the tracked object 106, e.g., for any of the tracked objects. For instance, the RF detector 110 can discard or otherwise delete the RF signal for a background object 104.

When the RF detector 110 is unable to determine to which object an RF signal likely corresponds, the RF detector 110 can determine to skip adding the incoming RF signal to any groups of scattered RF signals. This can occur when an RF signal is incomplete, does not match any of the background objects 104 or a tracked object 106, or a combination of both. This can occur when the likelihood threshold is not satisfied, e.g., for the one or more of the passive label or the background objects 104. For example, when a scattered RF signal is scattered because of movement of a person through the environment 100, the RF detector 110 can determine that the scattered RF signal likely does not match any of the background objects or any of the tracked objects 106. In response, the RF detector can determine to discard the incoming RF signal, e.g., and perform an operation similar to those described above for background objects 104.

The RF detector 110 can contain one or more AI models 112a-b to determine movement data, use data, or both, for the tracked object. For instance, the AI model 112a can use data for the scattered RF signals to predict movement, locate, use, or a combination of these, for the tracked object 106 in the environment 100 based on the detected scattered RF signals. The AI model 112a can be trained on any appropriate type of data, e.g., data for LoRa signals. The RF detector 110, e.g., the AI model 112, based on the location of the object 106, can generate mapping data that represents the likely movement of the tracked object 106 in the environment 100 over a period of time. In some instances, the one or more AI models 112a-b can be implemented at least in part on the computer system 116.

The RF detector 110 can detect the scattered RF signals and one or more properties of the scattered RF signals. The properties can include, for example, signal strength, backscatter communication, phase shift, time of flight, frequency changes, or a combination of two or more of these. In some examples, the properties can include orientation, tilt, or both, of the passive label 108. The scattered RF signal properties can be used as inputs to one or more AI models, AI Models A-B 112a-b, to locate the object 106 in the environment 100 and generate the mapping data of the object 106.

The one or more AI models, AI Models A-B 112a-b, can be used to run an AI algorithm, e.g., a machine learning algorithm, on the incoming scattered RF signals read by the RF detector 110 and the scattered signal properties to generate one or more types of output data about the tracked object 106. For example, the output data can be location data of the object 106 within the environment 100. In some instances, the AI model can use the location data to generate mapping data that represents the movement of the object 106 over a period of time, a predicted physical location of the object, e.g., in the corresponding environment, or both.

The RF detector 110 can maintain multiple AI models 112. Each of the AI models can be used for a different type of object, e.g., a water bottle and a bag of chips; to determine different properties for the tracked object 106, e.g., movement and use; or a combination of these.

The AI Models A-B 112a-b can be implemented on any appropriate device or system, e.g., the computer system 116 or the RF detector 110.

The RF detector 110 can transmit the mapping data of the tracked object 106 to the computer system 116. The computer system 116 can perform one or more operations on the mapping data, such as data analysis. In some examples, the computer system 116 can use the mapping data to generate recommendations on products to purchase, e.g., reorder. This can occur given the use of any particular object, object type, or combination of both. For instance, when the computer system 116 maintains a minimum quantity for an object type and detects, using the mapping data, consumption of an object of the object type, the computer system 116 can determine whether more of an object should be ordered. The object that should be ordered can be the same object, e.g., the same brand and product line. In some examples, the object that should be ordered can be a different object, e.g., a different brand, different product line, or combination of both. The computer system 116 can provide a recommendation, e.g., to a user device of a person who consumed the object or another associated person, to cause presentation of the recommendation. The recommendation can be a visual recommendation, an audible recommendation, or a combination of both.

The computer system 116 can determine the recommendation using any appropriate data in addition to the mapping data. For instance, the mapping data can be used to determine when an object should be ordered while different data for the environment 100, or different data generally, e.g., for a brand, can be used to determine what type of object should be recommended. Given various combinations of objects consumed in the environment, and other data for the person, e.g., to which the person has opted in to share, the computer system 116 can generate more accurate recommendations compared to other systems.

The environmental RF transmitter 102, the RF detector 110, and the computer system 116 are each examples of systems implemented as computer programs on one or more computers in one or more locations, in which the systems, components, and techniques described in this specification are implemented. The user device can include personal computers, mobile communication devices, and other devices that can send and receive data over a network. The network (not shown), such as a local area network (“LAN”), wide area network (“WAN”), the Internet, or a combination thereof, connects the computer system 116, and the RF detector 110. The computer system 116 can use a single computer or multiple computers operating in conjunction with one another, including, for example, a set of remote computers deployed as a cloud computing service.

The RF detector 110 can include several different functional components, including the AI Models A-B 112a-b, and the baseline model 114. The AI Models A-B 112a-b, the baseline model 114, or a combination of these, can include one or more data processing apparatuses, can be implemented in code, or a combination of both. For instance, each of the AI Models A-B 112a-b and the baseline model 114 can include one or more data processors and instructions that cause the one or more data processors to perform the operations discussed herein.

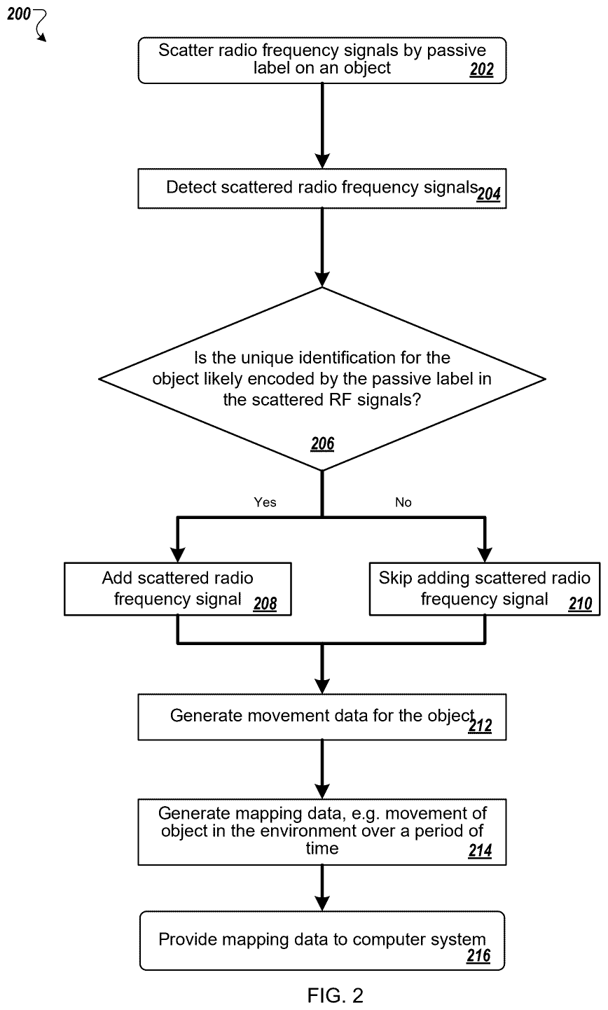

FIG. 2 is a flow diagram of an example process 200 for generating mapping data. For example, the process 200 can be used by the RF detector 110, the computer system 116, or a combination of both, from the environment 100.

A passive label on an object scatters an ambient RF signal emitted from one or more RF transmitters (202). The passive label represents a unique identification that encodes information into ambient RF signals scattered by the passive label. When the ambient RF signals, e.g., LoRa signals, interact with the passive label, the passive label scatters the ambient RF signals in a unique pattern and thus encodes identifying information into the scattered RF signals.

An RF detector detects the scattered RF signals (204). The RF detector, e.g., a LoRa detector, detects the scattered ambient RF signals from the passive label on the object and from one or more background objects in a physical environment. Using the scattered RF signals from the one or more background objects, the RF detector can build a baseline to eliminate noise from the incoming scattered RF signal.

The RF detector can detect a RF signal scattered by the passive label, e.g., an isolated signal of interest from the passive label. For instance, separately from detection the RF signals used to build the baseline, the RF detector can detect the scattered RF signals when the object with the passive label is in the environment.

The RF signals can be scattered in any appropriate manner. For instance, some of the RF signals can reflect off of the passive label. Some of the RF signals can pass by the passive label. The RF detector can detect any combination of these RF signals, and other appropriate RF signals, as the scattered RF signals.

A system determines if the unique identification for the object is likely encoded in the scattered RF signals (206). The system can include the RF detector, one or more AI models, or a combination of both. For instance, the RF detector can compare the baseline RF signal built from the background objects to the current incoming scattered RF signal and subtract the signals, e.g., to determine one or more isolated signals. The isolated signal can represent objects that are not included in the one or more background objects, optionally including the passive label. The RF detector can compare the isolated signal with the unique pattern for the passive label to determine if the unique identification for the object on the passive label is likely encoded in the current incoming signal.

When the system determines that the scattered RF signal likely encodes the unique identifier for the object, the system adds the scattered signal to a group of scattered RF signals (208). The group of scattered RF signals can be signals for the object that the system can use to locate the object within the environment, determine movement data, or a combination of both. The system can use the location data, movement data, or both, to generate mapping data of the object.

The location data can be any appropriate type of location data. For instance, the location data can indicate a predicted location of the object in a corresponding physical environment. The location data can indicate coordinates, e.g., Global Positioning System (“GPS”) coordinates; a room in which the object is likely located, e.g., kitchen or living room; another object within with the object is located, e.g., when the other object is a cabinet, a trash bin, or a pantry; another appropriate type of location data; or any combination of these.

In some examples, the system can predict the location data for the object using second location data for another product. For instance, the other product can include a label. When the system determines that the two labels are likely within a threshold distance of each other, the system can determine that the object is likely within the other object, whether the other object is a cabinet, pantry, or trash bin. In some instances, the system can use an artificial intelligence model to determine the location data for the object using the second location data for the other product. The system can provide the location data for the object and the second location data for the other product to the artificial intelligence model. In response, the system can receive output that indicates the predicted location data for the object.

When the system determines that the scattered RF signal likely does not encode the unique identifier for the object, the system determines to skip adding the scattered signal to a group of ambient RF signals scattered by the passive label on the object (210). The system will not use these scattered RF signals for generation of movement data for the object.

The system generates movement data for the object (212). The movement data can indicate the location of the object in the environment. In some instances, the movement data can indicate movement of the object in the environment across time. The system can determine the movement data by predicting the locations given the location of the RF detector, the angles of the RF signals, e.g., as the RF signals were scattered by the passive label that encode the unique identification of the object and one or more scattered RF signal properties, or a combination of both.

The system generates mapping data that represents the movement of the object in the environment over a period of time (214). The mapping data is generated based on the location, e.g., predicted location, of the object at a given time, movement of the object such as predicted movement of the object, or a combination of both. For instance, the system might not have data that indicates a particular location of the object at any given time. In these instances, the system can have data that indicates the movement of the object across time, e.g., the object moved left two feet, rotated, e.g., as a person consumed part of the object, and then moved forward three and a half feet.

The mapping data can indicate whether the object was used, an amount the object was used, whether the object has any product left, or any combination of these. For instance, if the system determines that the object was likely thrown in a trash bin, the system can predict that any product included in the object was likely used up and there is no product left. Given the movement data, if the system determines that there was likely product left even though the object was thrown in a trash bin, the system can augment the mapping data with other use data, e.g., indicating a predicted amount of the product that was left.

The system provides the mapping data to the computer system (216). Provision of the mapping data can cause the system to perform one or more actions. In instances when the computer system is the system that performs operation 214, the system can store the mapping data in memory, analyze the mapping data, e.g., to generate one or more recommendations, or a combination of both.

The order of operations in the process 200 described above is illustrative only, and the generation of the mapping data can be performed in different orders. For example, the process 200 can detect multiple different radio frequency signals across time, e.g., perform operation 204 across time. The process 200 can, using the multiple different radio frequency signals, group the signals, e.g., perform operation 206 for multiple different signals detected at different time instances. This can occur instead of performing operation 206 for a single radio frequency signal or set of radio frequency signals captured during a time period that together encode the unique identifier.

In some implementations, the process 200 can include additional operations, fewer operations, or some of the operations can be divided into multiple operations. For example, the process 200 can include operation 204 when generating a baseline model for the environment. In some instances, the process 200 can include operations 204, 206, and 210. The process 200 can include operations 204, 206, 208, and 212. The process can include operations 204, 206, 208, and 214.

In some implementations, by using a label, the process 200 can verify product usage. For instance, instead of data generated by a survey, the use of the label can generate data that is more accurate given the actual use of the object to which the label is attached. The process 200 can include filtering, by the computer system, of some of the mapping data. For instance, the computer system can filter data for objects that were used fewer than a low threshold number of times, e.g., once; use data for objects that were used more than a high threshold number of times, e.g., multiple to several times; weight mapping data according to a number of times a corresponding object was used; or a combination of one or more of these.

In some implementations, the label can be implemented as an active RF tag. The active RF tag can include a transducer, e.g., a self-powered transducer. The transducer can include a battery, a transmitter, or both. The transducer can scatter, e.g., generate, RF waves in a unique pattern, such as the patterns described above with respect to the passive label 108. In these implementations, the label can scatter the RF signals, e.g., perform operation 202, by generating at least some of the RF signals using the transducer. Some of the RF signals can optionally be scattered signals generated by another device, e.g., another RF transmitter.

The transmitter can be any appropriate type of transmitter, can emit waves of any appropriate frequency or frequency range, or any combination of both. For instance, the transmitter can be a LoRa transmitter. The transmitter can transmit RF waves.

When implemented as an active RF label, the label can include other electronics. For instance, the active RF label can include an accelerometer, a temperature sensor, a microcontroller, a receiver, or any combination of these. The active RF label can transmit, to the RF detector or another device, accelerometer data, temperature data, or both. Some examples of accelerometer data can include tilt data. The transmitted data can be combined with data about a detected pattern. For instance, the RF detector can combine the accelerometer data with data representing a detected pattern from an incoming RF signal to tracked data for an object to which the active RF label is attached. In some examples, at least some of the data can be encoded in the pattern. For instance, a first portion of the pattern can be the unique identifier for the object and a second portion of the pattern can encode the data generated by one or more sensors or other types of electronics included in the active RF label. By using additional electronics, such as an accelerometer, the tracked data can be more accurate. The microcontroller can control one or more operations of the active RF label. The receiver can receive one or more signals from another device, e.g., as part of network communications when the data is transmitted using a network.

The label, whether active or passive, can have any appropriate size, shape, or both. The label can have a rectangular shape. In some instances, the label can be approximately 40 by 20 millimeters (“mm”). When implemented as an active label, the label can be 0.5 to 1 mm thick.

As described above, the object can be any appropriate type of object. The object can be a durable good. The object can be a non-durable good. The object can be an analog product, e.g., food or an unpowered chair. In some instances, the object can be a digital object, e.g., a computer. The object can be a pharmaceutical container. The object can be, for instance, a medical device, a hair appliance, e.g., a hair iron or blow dryer, or a vacuum. When the object is a CPG, the object can be a beauty product, a skin product, a food item, a beverage, a household good such as a container for cleaning supplies, or an alcoholic beverage container such as for wine or spirits. In some examples, the object can be apparel. The object can be a shoe. The object can be a handbag. The object can be an accessory.

In some implementations, the object can be an object in a supply chain. By using a label, e.g., an active or passive label, a system, e.g., the computing system or RF detector or some combination of both, can track the object throughout the supply chain. When using a passive label, the system can perform the tracking across longer distances, e.g., when using a sub-gigahertz frequency, compared to other systems, e.g., RFID. When using a passive label, the system can track an object using fewer computational resources, e.g., by using less hardware than other systems. For example, the system can use existing hardware when tracking an object that has a passive label and need not require installation of much if any additional hardware to generate the FR signals.

In some implementations, the label can be used to generate analytics for object usage. For instance, a system can determine if, when, how much, how used, or any combination of these, regarding the object. The system can determine when, or predict when, an object will be used up or otherwise run out. This can be based on a percentage of object use, a number of times the object was used, an amount of the object that was used, or any combination of these. The system can provide a notification regarding the use of the object, automatically order a replacement object, or both. The replacement object can be of the same type, e.g., same brand and product, or a different type.

The system can select an operation to perform from multiple different types of operations. The system can make the selection using any appropriate data about the object, e.g., the movement data or other appropriate data about the object, objects within a threshold distance of the object, or any combination of both. For instance, the system can determine that the object is a product that should be taken according to a schedule, e.g., medication. When the system is tracking use of that object, given opt-in features as noted below, the system can update data for the tracking and provide a notification when the next use should occur.

In some instances, the system can determine a frequency of object use. The system can use that frequency when selecting an action to perform. For instance, the system can determine whether frequency of use of an object does not satisfy a frequency threshold, e.g., indicating that the object is used infrequently. In response to determining that the frequency threshold is not satisfied, the system can determine to provide a notification regarding the next use. When the frequency threshold is satisfied, the system can determine to skip providing a notification regarding the next use. The frequency threshold can vary given the object type, a typical use of the object, e.g., by other people given the analysis of mapping data for the object across people, other appropriate data, or any combination of these.

The system can generate data about an object's use at any appropriate time. For instance, the system can trigger one or more actions during object use, before object use, after object use, or any combination of these. In some instances, the system can trigger an action depending on a type of use, e.g., an amount vigor of use, a frequency of use, an amount of tilt during object use, or any combination of these.

For situations in which the systems discussed here collect personal information about people, such as information about how a person uses a product, or may make use of personal information, the people may be provided with an opportunity to control whether programs or features collect personal information (e.g., information about a person's activities, a person's preferences, a person's current location, or other demographic information), or to control whether and/or how the system operates. In addition, certain data may be anonymized in one or more ways before it is stored or used, so that personally identifiable information is removed. For example, a person's identity, to the extent such data is gathered, may be anonymized so that no personally identifiable information can be determined for the person, or a person's geographic location may be generalized where location information is obtained (such as generalized from a specific building to that type of building), so that a particular location of a person cannot be determined. Thus, the person may have control over how information is collected about him or her and used.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers. In some examples, an AI model can be implemented as part of an engine, e.g., that provides data to and receives data from the AI model.

In this specification, the term “likely” is used to mean that there is a likelihood that something might occur and that the likelihood satisfies a likelihood threshold. For instance, when determining that a signal likely encodes identifying information, a system would determine a likelihood that the signal encodes the identifying information. The system would then determine whether the likelihood satisfies, e.g., is greater than or equal to, a likelihood threshold by comparing the two values. If so, the system determines that the signal likely encodes the identifying information. If not, the system determines that the signal likely does not encode the identifying information.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

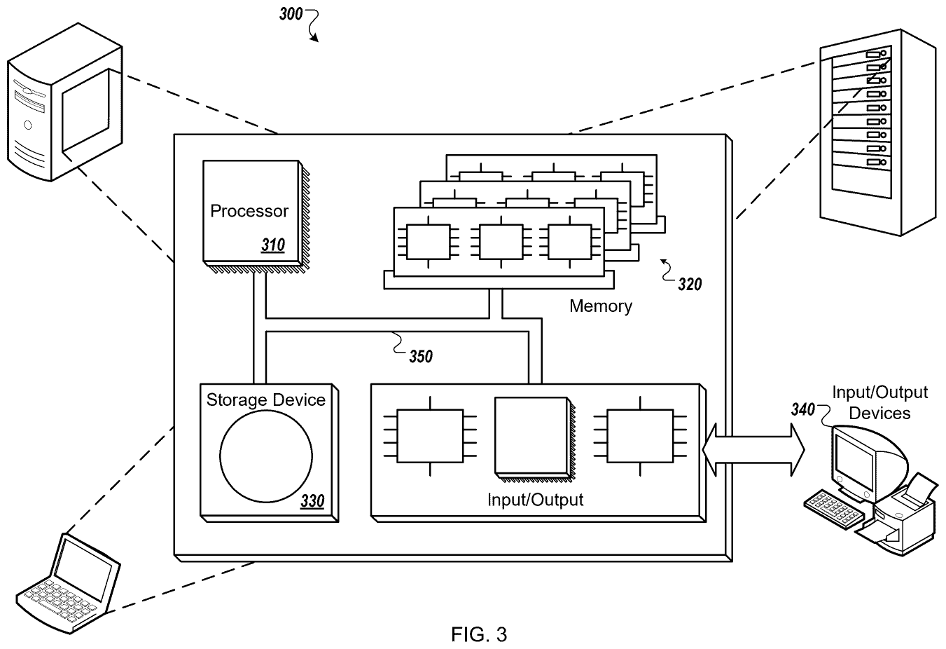

An example of one such type of computer is shown in FIG. 3, which shows a schematic diagram of a computer system 300. The computer system 300 can be used for the operations described in association with any of the computer-implemented methods described previously, according to some implementations. The computer system 300 includes a processor 310, a memory 320, a storage device 330, and an input/output device 340. Each of the components 310, 320, 330, and 340 are interconnected using a system bus 350. The processor 310 is capable of processing instructions for execution within the computer system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the computer system 300. In some implementations, the memory 320 is a computer-readable medium. In some implementations, the memory 320 is a volatile memory unit. In some implementations, the memory 320 is a non-volatile memory unit.

The storage device 330 is capable of providing mass storage for the computer system 300. In some implementations, the storage device 330 is a computer-readable medium. In some implementations, the storage device 330 can be a floppy disk device, a hard disk device, an optical disk device, or a tape device.

The input/output device 340 provides input/output operations for the computer system 300. In some implementations, the input/output device 340 includes a keyboard, a pointing device, a touchscreen, or a combination of these. In some implementations, the input/output device 340 includes a display unit for displaying graphical user interfaces. In some implementations, the input/output device 340 includes a microphone, a speaker, or a combination of both.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A method for tracking an object within an environment exposed to ambient radio frequency (“RF”) signals, the method comprising:
detecting, using one or more detectors in the environment, scattered radio frequency signals scattered by a label attached to an object, the label comprising at least one layer of material that encodes information into ambient radio frequency signals scattered by the label, the information comprising identifying information that uniquely identifies the object;
locating, based on the scattered radio frequency signals, the object in the environment;
generating, based on the location, mapping data that represents movement of the object in the environment over a period of time; and
providing the mapping data to a computer system for analysis.

2. The method of claim 1, comprising:
for each of at least two or more of a plurality of ambient radio frequency signals scattered by the label attached to the object:
determining whether the scattered radio frequency signal likely encodes the identifying information that uniquely identifies the object;
for at least a first radio frequency signal from the plurality of ambient radio frequency signals and in response to determining that the scattered radio frequency signal likely encodes the identifying information that uniquely identifies the object:
adding the scattered radio frequency signal to a group of scattered radio frequency signals for the object and that will be used to generate the mapping data; and
for at least a second radio frequency signal from the plurality of ambient radio frequency signals and in response to determining that the scattered radio frequency signal likely does not encode the identifying information that uniquely identifies the object:
determining to skip adding the scattered radio frequency signal to the group of scattered radio frequency signals for the object,
wherein generating the mapping data that represents the movement of the object in the environment uses the scattered radio frequency signals from the group of scattered radio frequency signals.

3. The method of claim 1, comprising:
for each of at least one or more of a plurality of scattered radio frequency signals, determining whether the scattered radio frequency signal likely encodes the identifying information that uniquely identifies the object; and
for a first radio frequency signal from the plurality of scattered radio frequency signals and in response to determining that the scattered radio frequency signal likely encodes the identifying information that uniquely identifies the object, adding the scattered radio frequency signal to a group of scattered radio frequency signals for the object and that will be used to generate the mapping data,
wherein generating the mapping data that represents the movement of the object in the environment uses the scattered radio frequency signals from the group of scattered radio frequency signals.

4. The method of claim 3, wherein determining whether the scattered radio frequency signal likely encodes the identifying information that uniquely identifies the object comprises:
maintaining a database of unique identifiers each of which are for a different object of a plurality of objects and each of which have a different radio frequency scatter pattern; and
determining, for at least one unique identifier from the database, that the scattered radio frequency signal likely encodes a scatter pattern for the identifying information that uniquely identifies the object.

5. The method of claim 1, comprising emitting, by one or more emitters, at least one of the radio frequency signals.

6. The method of claim 5, wherein at least one of the one or more detectors comprises at least one of the one or more emitters.

7. The method of claim 1, wherein the label attached to the object comprises a passive label that was printed onto the object.

8. The method of claim 1, wherein the label comprises a passive label, the method comprising printing the passive label onto the object.

9. The method of claim 1, wherein the label comprises a passive label.

10. The method of claim 1, wherein the label comprises an active label that includes a transducer.

11. The method of claim 10, wherein the transducer comprises a battery and a transmitter.

12. The method of claim 1, wherein providing the mapping data to the computer system causes the computer system to analyze the mapping data and perform an action using a result of the analysis of the mapping data.

13. The method of claim 1, wherein providing the mapping data to the computer system causes the computer system to analyze the mapping data, select, from a plurality of different actions and using a result of the analysis of the mapping data, an action, and perform the action.

14. The method of claim 13, wherein the action comprises generating a recommendation.

15. The method of claim 13, wherein the action comprises requesting a replacement object.

16. One or more computer storage media for tracking an object within an environment exposed to ambient radio frequency (“RF”) signals and encoded with instructions that, when executed by one or more computers, cause the one or more computers to perform operations comprising:
detecting, using one or more detectors in the environment, scattered radio frequency signals scattered by a label attached to an object, the label comprising at least one layer of material that encodes information into ambient radio frequency signals scattered by the label, the information comprising identifying information that uniquely identifies the object;
locating, based on the scattered radio frequency signals, the object in the environment;
generating, based on the location, mapping data that represents movement of the object in the environment over a period of time; and
providing the mapping data to a computer system for analysis.

17. The media of claim 16, the operations comprising:
for each of at least two or more of a plurality of ambient radio frequency signals scattered by the label attached to the object:
determining whether the scattered radio frequency signal likely encodes the identifying information that uniquely identifies the object;
for at least a first radio frequency signal from the plurality of ambient radio frequency signals and in response to determining that the scattered radio frequency signal likely encodes the identifying information that uniquely identifies the object:
adding the scattered radio frequency signal to a group of scattered radio frequency signals for the object and that will be used to generate the mapping data; and
for at least a second radio frequency signal from the plurality of ambient radio frequency signals and in response to determining that the scattered radio frequency signal likely does not encode the identifying information that uniquely identifies the object:
determining to skip adding the scattered radio frequency signal to the group of scattered radio frequency signals for the object,
wherein generating the mapping data that represents the movement of the object in the environment uses the scattered radio frequency signals from the group of scattered radio frequency signals.

18. The media of claim 16, the operations comprising:
for each of at least one or more of a plurality of scattered radio frequency signals, determining whether the scattered radio frequency signal likely encodes the identifying information that uniquely identifies the object; and
for a first radio frequency signal from the plurality of scattered radio frequency signals and in response to determining that the scattered radio frequency signal likely encodes the identifying information that uniquely identifies the object, adding the scattered radio frequency signal to a group of scattered radio frequency signals for the object and that will be used to generate the mapping data,
wherein generating the mapping data that represents the movement of the object in the environment uses the scattered radio frequency signals from the group of scattered radio frequency signals.

19. The media of claim 18, wherein determining whether the scattered radio frequency signal likely encodes the identifying information that uniquely identifies the object comprises:
maintaining a database of unique identifiers each of which are for a different object of a plurality of objects and each of which have a different radio frequency scatter pattern; and
determining, for at least one unique identifier from the database, that the scattered radio frequency signal likely encodes a scatter pattern for the identifying information that uniquely identifies the object.

20. A system for tracking an object within an environment exposed to ambient radio frequency (“RF”) signals and comprising one or more computers and one or more storage devices on which are stored instructions that are operable, when executed by the one or more computers, to cause the one or more computers to perform operations comprising:
detecting, using one or more detectors in the environment, scattered radio frequency signals scattered by a label attached to an object, the label comprising at least one layer of material that encodes information into ambient radio frequency signals scattered by the label, the information comprising identifying information that uniquely identifies the object;
locating, based on the scattered radio frequency signals, the object in the environment;
generating, based on the location, mapping data that represents movement of the object in the environment over a period of time; and
providing the mapping data to a computer system for analysis.
